(19) United States
(12) Patent Application Publication
(10) Pub. No.: US 2006/0023270 A1
(43) Pub. Date: Feb. 2, 2006

(54) Sheet handling device

(76) Inventor: Francesco Valentinis, Naviglio (MI) (IT)

Correspondence Address: YOUNG & THOMPSON, 745 SOUTH 23RD STREET, 2ND FLOOR, ARLINGTON, VA, 22202, US

(21) Appl. No.: 11/189,813

(22) Filed: Jul. 27, 2005

(30) Foreign Application Priority Data
Jul. 28, 2004 (IT) MI2004A001540

(51) Int. Cl. H04N 1/04

(52) U.S. Cl. 358/498

(57) ABSTRACT

A sheet handling device comprising a cutting member (1) for cutting at least one sheet (A) produced by industrial printers to obtain two sheets (B) there from, and a control member (3) for distributing the sheets obtained in this manner by directing them towards suitable post-print document processing devices.

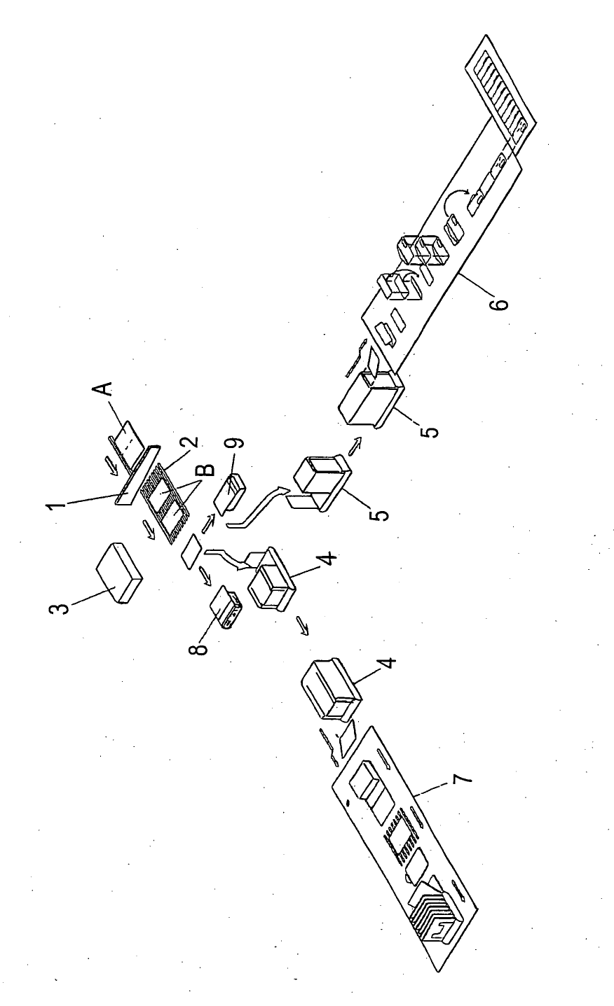

The present invention relates to a sheet handling device in accordance with the introduction to the main claim.

In the state of the art, those offices and departments using industrial printers, for example for printing employee's pay-packets, print on sheets of A4 format which, after printing, are sorted, then stacked in vertical collectors and subsequently inserted into a machine for envelope filling or for binding.

Currently, the printing cost is fixed for each printed sheet format by a debiting mechanism, hence for those offices having to process large quantities of documents the total printing costs are proportional to the quantity of sheets processed by the printers.

It is very common to use industrial printers to print documents consisting of several A4 sheets with sheet quantities variable between one document and the next in the printing sequence. Whatever their format, the printed sheets are commonly collected in receivers which stack the sheets vertically by laying them extended one on another. In order not to interrupt the printing process, when a first vertical receiver is full the A4 sheets are fed to a second vertical receiver via a bypass device on the first vertical receiver.

With current printing programs commonly used for printers, it is never possible to ensure that all the documents of variable sheet quantities are completely collected in the first vertical receiver, so that it can happen that a document has part of its sheets collected in the top of the stack of the first vertical receiver and part of its sheets in the bottom of the stack of the second receiver.

For subsequent post-print handling of the documents, whether envelope filling or binding, the documents have to be worked while maintaining them in the sequence in which they were printed. If the machines used for envelope filling or binding were to handle the stacks of sheets of the vertically collected documents as extracted by the printers which withdraw the sheets from the top of the stack, the document printing sequence would be altered and there would be the risk of not being able to complete document processing where part of the sheets have finished at the bottom of the first row of the first vertical receiver and the remaining sheets of the same document have finished at the bottom of the stack of the next vertical receiver.

The solution universally used consists of manually unloading the sheets from the various vertical receivers of the printers, taking care that the document print sequence is maintained when loading the sheets onto the sheet feeders of the envelope or binding machines. This manual procedure implies risks of error in the post-print processing stages besides a general productivity loss in the entire document processing, printing and distribution procedure.

With usual print cost debiting mechanisms based on the “click charge” concept, the cost of printing an A3 sheet is the same as the cost of printing an A4 sheet, hence the printer user could print A4 page documents on A3 sheets, collect them in the usually used vertical receivers and, before passing to subsequent envelope filling or binding, divide the stack of A3 sheets into two stacks of A4 sheets using industrial guillotines. However this procedure would not be practicable because all control over the sheet sequence in the documents would be completely lost.

An object of the present invention is therefore to provide a device and process which overcome the aforesaid drawbacks.

A particular object is to reduce the print costs and times by printing documents on A3 sheets, forming coherent A4 documents by cutting each A3 sheet along its short side, and collecting the documents in A4 format.

A further object is to simplify the feed of sheets to the envelope or binding machine by providing a method for collecting A4 documents on horizontal receivers insertable into the printing machine, which maintain the sheets in a vertical position and in the correct print sequence even if the collection of a document print flow is divided between two or three horizontal receivers.

Said objects are attained by a device and process, the inventive characteristics of which are defined in the claims.

The invention will be more apparent from the ensuing detailed description, provided by way of non-limiting example, of a preferred embodiment thereof illustrated in the accompanying drawing, in which the single FIGURE shows a preferred embodiment of the device according to the invention.

Current printers are controlled electronically and can print on either A4 sheets or A3 sheets, distributing the print on the sheets in the manner desired by the user.

The FIGURE shows a preferred embodiment of the device of the invention, comprising a cutting member 1 for cutting the A3 sheets A originating from a printer (not shown) able to print on both A3 and A4 sheets, to produce from each A3 sheet two A4 sheets B, a conveying member 2 for the sheets, a control member 3 able to distribute the sheets by moving them to the right or left, depending on the desired collecting method, towards one or more horizontal removable receivers 4, 5 which stack the sheets vertically and are to be used as loaders for one or more manipulator machines, for example an envelope machine 6 or binding machine 7. The same control member 3 is able to feed the sheets cut into A4 format to two interceptor and collector devices 8 and 9 should any irregularities occur while printing the sheets or reducing them from A3 format to A4 format. Depending on the requirements of the subsequent post-print process, the sheets transformed into A4 format can be stacked vertically resting either on their short side or on their long side. The receivers comprise a sheet carrier belt and a movable wall ensuring that the sheets are compacted, hence enabling them to be stacked vertically on the horizontal receivers while maintaining the correct print sequence.

The text which is to be carried on two A4 sheets is printed on one A3 sheet, resulting in both a reduction in cost, which is calculated on the basis of the number of sheets printed independently of their dimensions, and a reduction in time due to the elimination of the time required for feeding a double quantity of A4 sheets to the printer.

The A3 sheet is then cut into two A4 parts by a cutting member 1 fed by a conveying member 2.

After the printing and cutting operation, the resultant A4 sheets are inserted into a control member 3, able to shift the sheets towards the right or left, to distribute them to suitable receivers 4 and 5. These horizontal receivers 4 and 5 in which the sheets are vertically stacked, are preferably of horizontal stacking type and present the characteristic of being removable and usable as loaders for envelope machines 6 or binding machines 7. This characteristic is particularly advantageous because it enables the sheets to be inserted into the envelope machines 6 and binding machines 7 in the order in which they were printed.

The accompanying FIGURE shows an example of a printer from which the A3 sheets are expelled along a direction from right to left, however it is apparent that the same concepts apply if the sheets are expelled along other directions, and in particular from left to right.

The present invention also relates to a process which comprises the following steps:
printing the text intended for two documents of A4 format onto a single sheet of A3 format;
cutting the A3 sheet into two A4 sheets;
distributing the A4 sheets to various removable horizontal receivers 4, 5 with vertical stacking of the A4 sheets and with maintenance of the correct print sequence, or possible discarding any blank or badly printed sheets;
intercepting and collecting sheets which are not to be fed to subsequent post-print operations;
disconnecting the removable receivers 4, 5 from the printer and connecting them to suitable envelope machines 6 and/or binding machines 7;
withdrawing the A4 sheets in succession by the envelope machines 6 and/or binding machines 7.

As the device prints on A3 sheets which are then each divided into two A4 sheets collected in the correct print sequence, there is a considerable cost saving during printing and a considerable improvement in the subsequent post-print processes in terms both of safety and of efficiency.

A further advantage is the fact that the removable horizontal receivers 4, 5 allow vertical stacking of the printed sheets and can then act as loaders for envelope machines 6 or binding machines 7 while maintaining the print order.

1. A sheet handling device comprising a cutting member (1) for cutting at least one sheet (A) to obtain two sheets (B) therefrom, and a control member (3) for distributing the sheets obtained in this manner by directing them towards suitable post-print document processing devices.

2. A device as claimed in claim 1, characterised by being arranged to cut at least one sheet of A3 format to obtain two sheets of A4 format.

3. A device as claimed in claim 2, characterised in that said control member (3) comprises a device for intercepting and collecting sheets which are not to be fed to subsequent post-print processes.

4. A device as claimed in claim 1, characterised by comprising at least one removable sheet receiver (4, 5).

5. A device as claimed in claim 4, characterised in that in said horizontal receiver (4, 5) the sheets are stacked in a vertical position.

6. A device as claimed in claim 4, characterised in that said horizontal receiver for vertical stacking (4, 5) comprises a sheet carrier belt and a movable compacting wall.

7. A device as claimed in claim 4, characterised in that said receiver (4, 5) can be used as a loader for at least one manipulator machine (6, 7).

8. A sheet handling process characterised by the following steps:
cutting at least one sheet into two parts to obtain two separate sheets;
intercepting sheets which are not to be fed to subsequent post-print processes;
distributing the sheets towards horizontal receivers for vertical stacking, in which the A4 sheets are stacked resting either on their long side (4) or on their short side (5).

9. A sheet handling process as claimed in claim 8, characterised by cutting A3 sheets in half to obtain A4 sheets.

10. A sheet handling process as claimed in claim 8, characterised in that after distribution, the sheets are stacked in suitable removable receivers.

11. A sheet handling process as claimed in claim 8, characterised in that the sheets are stacked horizontally in a vertical position and maintained in the correct print sequence.

12. A sheet handling process as claimed in claim 10, characterised by detaching the removable receivers and using them as loaders for manipulator machines (7, 8).
